(19) United States
(12) Patent Application Publication
(10) Pub. No.: US 2021/0200741 A1
(43) Pub. Date: Jul. 1, 2021

(54) PASSIVE CLASSIFICATION OF DATA IN A DATABASE BASED ON AN EVENT LOG DATABASE

(71) Applicant: Imperva, Inc., Redwood City, CA (US)

(72) Inventors: Or FRENKEL, Tel Aviv (IL); Reut SHANI, Tel Aviv (IL); Itsik MANTIN, Shoham (IL); Ran GERSON, Tel Mond (IL); Alexei OVSEITCHIK, Rishon LeTsiyon (IL); Joseph C. G. BULLEN, St. John's (CA); Derrick J. HANCOCK, Flatrock (CA); Chadwick R. THORNE, St. John's (CA)

(73) Assignee: Imperva, Inc., Redwood City, CA (US)

(21) Appl. No.: 16/730,769

(22) Filed: Dec. 30, 2019

(51) Int. Cl. G06F 16/23; G06F 16/28; G06F 9/46

(52) U.S. Cl. CPC G06F 16/2358; G06F 9/466; G06F 16/288; G06F 16/285

(57) ABSTRACT

A method for passively classifying data in a database based on event logs stored in an event log database is described. The method includes retrieving, by a classification server, a first event log from the event log database, wherein the first event log represents a transaction involving a client device and the database; extracting, by the classification server, one or more pieces of information from the first event log to generate classification data; generating, by the classification server, a set of sensitivity scores corresponding to the one or more pieces of information, wherein each sensitivity score indicates the level of sensitivity associated with a corresponding piece of information from the one or more pieces of information; and storing, by the classification server, the set of sensitivity scores in a score database.

### TECHNICAL FIELD

Embodiments of the invention relate to the field of classification of data, and more specifically, to classification of sensitivity of data in a database based on an event log database.

### BACKGROUND ART

Database servers are computer programs that provide database services to other computer programs, which are typically running on other electronic devices and adhering to the client-server model of communication. Many web applications utilize database servers (e.g., relational databases to store information received from Hypertext Transfer Protocol (HTTP) clients and/or information to be displayed to HTTP clients). However, other non-web applications may also utilize database servers, including but not limited to accounting software, other business software, or research software. Further, some applications allow for users to perform ad-hoc or defined queries (often using Structured Query Language (SQL)) using the database server. Database servers typically store data using one or more databases. Thus, in some instances, a database server can receive a SQL query from a client (directly from a database client process or client end station using a database protocol, or indirectly via a web application server that a web server client is interacting with), execute the SQL query using data stored in the set of one or more database objects of one or more of the databases, and may potentially return a result (e.g., an indication of success, a value, one or more tuples, etc.).

Databases may be implemented according to a variety of different database models, such as relational (such as PostgreSQL and MySQL), non-relational, graph, columnar (also known as extensible record (e.g., HBase)), object, tabular, tuple store, and multi-model. Examples of non-relational database models, which are also referred to as schema-less and NoSQL, include key-value store and document store (also known as document-oriented as they store document-oriented information, which is also known as semi-structured data). A database may comprise one or more database objects that are managed by a Database Management System (DBMS), each database object may include a number of records, and each record may comprise of a set of fields/columns. A record may take different forms based on the database model being used and/or the specific database object to which it belongs; for example, a record may be: 1) a row in a table of a relational database; 2) a JavaScript Object Notation (JSON) document; 3) an Extensible Markup Language (XML) document; 4) a key-value pair; etc. A database object can be unstructured or have a structure defined by the DBMS (a standard database object) and/or defined by a user (custom database object). In a cloud database (i.e., a database that runs on a cloud platform and that is provided as a database service), identifiers are used instead of database keys, and relationships are used instead of foreign keys. In the case of relational databases, each database typically includes one or more database tables (traditionally and formally referred to as “relations”), which are ledger-style (or spreadsheet-style) data structures including columns (often deemed “attributes”, or “attribute names”) and rows (often deemed “tuples”) of data (“values” or “attribute values”) adhering to any defined data types for each column.

Data in a database may include sensitive data and non-sensitive data. For example, sensitive data is data that should be protected from unauthorized access to safeguard the privacy or security of an individual or organization. Sensitive data can include personal or financial information. For instance, personal information can include personally identifiable information (PII) that can be traced back to an individual or organization and that, if disclosed, could result in harm to that person or organization. Such information can include biometric data, medical information, and unique identifiers (e.g., passport or Social Security numbers). Financial information can include banking or credit information, such as bank and credit account numbers. Threats to personal and financial information, which may result from exposure of this sensitive data, include not only crimes such as identity theft and financial theft but also disclosure of personal information that the individual/organization would prefer remained private.

### BRIEF DESCRIPTION OF THE DRAWINGS

The invention may best be understood by referring to the following description and accompanying drawings that are used to illustrate embodiments of the invention. In the drawings:

FIG. 1 is a block diagram, according to some embodiments, illustrating a system for passively classifying information in a database based on event logs stored in an event log database.

FIG. 2 shows an example of two event logs, according to some example embodiments.

FIG. 3 shows a table of classification data and corresponding sensitivity scores, according to one example embodiment.

FIG. 4 shows a method for passively classifying information in a database based on event logs stored in an event log database, according to some example embodiments.

FIG. 5 is a block diagram illustrating an electronic device according to some example implementations.

### DETAILED DESCRIPTION

In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

Bracketed text and blocks with dashed borders (e.g., large dashes, small dashes, dot-dash, and dots) are used herein to illustrate optional operations that add additional features to embodiments of the invention. However, such notation should not be taken to mean that these are the only options or optional operations, and/or that blocks with solid borders are not optional in certain embodiments of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Various embodiments are described herein for classifying data stored or otherwise associated with a database based on a sensitivity of the data. In particular, classification logic is applied to an event log database, which stores event logs associated with the database. The event log database stores event logs corresponding to transactions or other operations related to data in the database. For example, the event logs can represent modifications to records in the database, insertions of records into the database, and/or deletions of records in the database. In this configuration, (1) the sensitivity of the data stored in the database and reflected in the event log database is determined based on the event logs instead of the database itself and (2) the sensitivity determination/scores can be stored for later use. Accordingly, through the use of the event log database, the classification logic can passively classify data stored in the database without accessing or even having access to the database. Further details regarding this process and technique will be described in greater detail herein by way of example.

While embodiments may use one or more databases implemented according to one or more of the different database models previously described, a relational database with tables is sometimes described to simplify understanding. In the context of a relational database, each relational database table (which is a type of database object) can contain one or more data categories logically arranged as columns according to a schema, where the columns of the relational database table are different ones of the fields from the plurality of records, and where each row of the relational database table are different ones of a plurality records and contains an instance of data for each category defined by the fields. Thus, the fields of a record are defined by the structure of the database object to which it belongs.

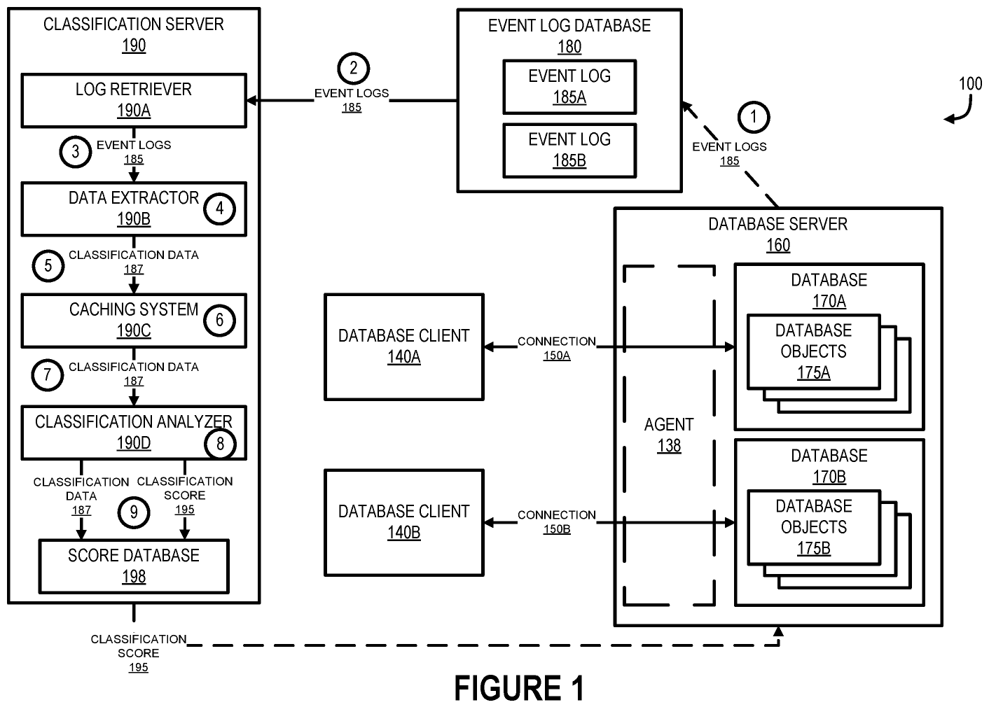

FIG. 1 is a block diagram, according to some embodiments, illustrating a system 100 for passively classifying data/information in a database 170 based on event logs 185 (sometimes referred to as events 185, event information 185, event entries 185, or event log entries 185) stored in an event log database 180. As shown in FIG. 1, the system 100 includes database clients 140A and 140B, a database server 160, the event log database 180, and a classification server 190 (sometimes referred to as classification logic 190).

The database server 160 can host one or more databases 170. In the example shown in FIG. 1, the database server 160 hosts two databases: the database 170A and the database 170B. Each database 170 includes one or more database objects 175 that store various pieces of data related to (1) users of or (2) entities associated with the database clients 140A and 140B. In the example of FIG. 1, the database 170A includes the database objects 175A and the database 170B includes the database objects 175B. Although shown with two database clients 140 and two corresponding databases 170, the system 100 may include additional database clients 140 and additional databases 170. Further, in some embodiments, two or more database clients 140 may access or otherwise use the same database 170 (e.g., the database clients 140A and 140B may both have access to or otherwise utilize the database 170A and/or the database 170B). In one embodiment, the database server 160 includes an agent 138 (sometimes referred to as a database agent 138), which is described in further detail below.

As previously mentioned, the databases 170 may be implemented according to a variety of different models (e.g., relational, non-relational, graph, columnar, object, tabular, tuple store, and multi-model). In an embodiment where the databases 170 are relational databases, the database objects 175 may be database tables. However, in other embodiments where the databases 170 are implemented according to a different model (e.g., a non-relational model), the database objects 175 may be implemented using a different storage scheme/schema.

As noted above and shown in FIG. 1, the database clients 140 may establish connections 150 to one or more databases 170 to access those databases 170 (e.g., access for transmission of commands, requests, or queries). For example, as shown in FIG. 1, the database client 140A has established a connection 150A to the database 170A, while the database client 140B has established a connection 150B to the database 170B. These connections 150 may be established over one or more networks. Each database client 140 can access one or more databases 170 by submitting commands (e.g., Structured Query Language (SQL) queries) to the database server 160 over a connection 150 established with that database 170. These commands could include, for example, commands to read one or more records from a specified database object 175 of a database 170, modify the records of a specified database object 175 of a database 170 (e.g., update or insert a record to a specified database object 175), and/or delete records from a specified database object 175 of a database 170.

In one embodiment, the database server 160 maintains an event log database 180. The event log database 180 is composed of event logs 185 that record the transactions and/or operations made against the databases 170 (e.g., as a result of interactions between the database clients 140 and the databases 170), which can include a request/query and/or a response/query result side of the transactions. In one embodiment, the event log database 180 is proximate to the database server 160, while in other embodiments, the event log database 180 is located separate from the database server 160. For instance, in some embodiments, the event log database 180 can be located within the database server 160 while in other embodiments, the event log database 180 may be separate from the database server 160 (as shown in FIG. 1). In either case, access to the event log database 180 is separate from access to the database server 160 such that a client of the system 100 can gain access to the event log database 180 without accessing or having access to (i.e., permission to access) the database server 160. In some embodiments, the event log database 180 can maintain a separate set of event logs 185 per each corresponding database 170. For example, the event log database 180 can maintain (1) a first set of event logs 185 that represent transactions and/or operations relative to the database 170A and (2) a second set of event logs 185 that represent transactions and/or operations relative to the database 170B. For instance, the event log 185A may be generated for the database 170A and the event log 185B may be generated for the database 170B. As will be described herein, the classification server 190 can classify information stored in the databases 170 based on the event log database 180 rather than through access to the actual databases 170.

As shown in FIG. 1, the classification server 190 includes a log retriever 190A (also referred to as a log collector 190A), a data extractor 190B, a caching system 190C, a classification analyzer 190D, and a score database 198. Each of these elements of the classification server 190 may be used for determining a classification score 195 (sometimes referred to as a sensitivity score 195) in relation to the sensitivity of data stored in the databases 170 based on the event log database 180.

In particular, data in the databases 170 may include sensitive data and non-sensitive data. For example, sensitive data is data that should be protected from unauthorized access to safeguard the privacy or security of an individual or organization (e.g., a user of a client device 140). Sensitive data can include personal or financial information. For instance, personal information can include personally identifiable information (PII) that can be traced back to an individual/user or associated entity/organization and that, if disclosed, could result in harm to that individual/user or entity/organization. Such information can include biometric data, medical information, and unique identifiers (e.g., passport or Social Security numbers). Financial information can include banking or credit information, such as bank and credit account numbers. Threats to personal and financial information, which may result from exposure of this information, include not only crimes such as identity theft and financial theft but also disclosure of personal information that the individual/user or associated entity/organization would prefer remained private. The classification server 190 may calculate and assign a classification score 195 to distinguish sensitive data involved in a transaction with a database 170 and non-sensitive or less sensitive data involved in a transaction with a database 170. For example, the classification server 190 may generate a higher classification score 195 for a first piece of data that is deemed to be more highly sensitive than a second piece of data that is deemed to be less highly sensitive and consequently receives a lower classification score 195 (relative to the first piece of information). For example, the first piece of data can be a social security number while the second piece of data can be an age of a user.

As noted above, in one embodiment, the database server 160 may include a database agent 138. The database agent 138 is a piece of software, typically installed locally to the databases 170, that is configured to monitor processes of the databases 170 (and thus able to monitor transactions/operations involving the databases 170). Thus, access to the databases 170 can be thought of as being monitored by the agent 138, as most or all interactions with the databases 170 may pass through or otherwise be seen by the agent 138. While FIG. 1 shows a single agent 138 that monitors accesses to both databases 170A and 170B, in other embodiments, each database 170 in the database server 160 may have a separate agent 138 that monitors accesses to that database 170. In one embodiment, there is a separate agent 138 for each database vendor type (e.g., separate agents 138 for Oracle databases, MySQL databases, and Mongo databases). While FIG. 1 shows the agent 138 as being implemented inside the database server 160, in other embodiments, the agent 138 may be implemented outside of the database server 160. The agents 138 may have a link to processes of the database 170, which allow the agent 138 to monitor accesses to the databases 170. In one embodiment, the agent 138 generates event logs 185 that record the transactions/operations it has seen made against the databases 170 and/or the interactions between the database clients 140 and the database server 160 it has seen and stores these as part of the event log 185. Thus, the event logs 185 can be generated by the database server 160, including the agent 138. Each event log 185 in the event log database 180 can include various parameters and other information regarding the transactions/operations made against the databases 170 and/or the interactions between the database clients 140 and the databases 170. As used herein, a database transaction or a transaction refers to a unit of work performed against a database 170 (e.g., this can include reading a record, inserting a record, deleting a record, etc.). The term database transaction or transaction is not limited to a particular type of database model but can include accesses to databases 170 utilizing various different database models previously described. Also, different embodiments of the system 100 described herein may operate on one or both of the request/query side and the response/query result side of the database transactions. Although primarily described in relation to event logs 185 being generated in relation to transactions/operations involving the database clients 140, in other embodiments, the event logs 185 can also be generated in relation to transactions/operations not involving the database clients 140. For example, an event log 185 can be generated in response to an internal operation of a database 170 (e.g., an event log 185 can be generated in response to a data optimization procedure performed by the database server 160 in relation to a database 170).

Exemplary operations for classifying the sensitivity of data stored in a database 170 based on the event log database 180, which maintains event logs 185 reflecting operations/transactions involving the databases 170, will now be described with reference to the system 100 of FIG. 1. In some embodiments, the techniques described in relation to FIG. 1 can include additional operations than those shown and described. Accordingly, the techniques described in relation to FIG. 1 are for purposes of illustration.

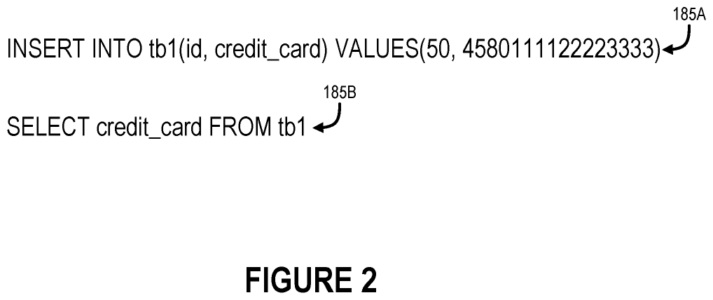

At circle 1, the event log database 180 and/or the database server 160, including the agent 138, generates and stores an event log 185 in the event log database 180. The event log 185 reflects a transaction/operation conducted in relation to one or more records in a database 170 of the database server 160. For example, the database client 140A may have transmitted updated information to be stored in a database object 175A of the database 170A (e.g., an identifier of a user of the database client 140A and/or a credit card account number associated with the user of the database client 140A). In response to this transaction/operation, the agent 138 and/or the event log database 180 may generate an event log 185, which may include various parameters and information that reflects this transaction/operation. FIG. 2 shows an example of two event logs 185. A first event log 185A corresponds to an insertion of a credit card number (i.e., the credit card number of 4580111122223333) into a table of a database 170 (i.e., table tb1), while a second event log 185B corresponds to a retrieval/selection of a credit card number from a table of a database 170 (i.e., table tb1). In these examples, the first event log 185A includes sensitive information (i.e., the credit card number of 4580111122223333), while the second event log 185B does not include any sensitive information as it is simply a request without any identifying information (e.g., identity information of either a user or an account of a user). In some embodiments, the event log 185 can include the response to the original query/request. In this case, the second event log 185B can include the credit cards numbers that are provided in response to the original query/request. In this case, the event log 185B would include sensitive information as it includes credit card numbers, similar to the event log 185A.

At circle 2, the log retriever 190A retrieves one or more event logs 185 from the event log database 180. For example, the log retriever 190A can retrieve the event log 185A shown in FIG. 2 at circle 2. In one embodiment, the log retriever 190A requests the one or more event logs 185 from the event log database 180, which hosts event logs 185 (i.e., the log retriever 190A polls the one or more event logs 185 from the event log database 180 at circle 2 (i.e., a pull technique)), while in another embodiment, the event log database 180 pushes event logs 185 to the log retriever 190A based on a triggering event at circle 2 (e.g., event logs 185 are automatically transmitted to the log retriever 19A based on a period of time being elapsed (i.e., periodically) or as a new event log 185 becomes available).

At circle 3, the log retriever 190A provides the one or more event logs 185 to the data extractor 190B such that the data extractor 190B can extract relevant data from the one or more event logs 185 at circle 4 for purposes of data classification. In particular, the data extractor 190B analyzes the one or more event logs 185 received from the log retriever 190A to determine whether the event logs 185 includes data useful in gauging the sensitivity of data provided therein, which is also stored in one or more of the databases 170. This information may include one or more column/field names, one or more entity names, and one or more pieces of content (e.g., one or more identifiers of a user or one or more account numbers of a user) as indicated in an event log 185. For example, each of the column names referenced in the event logs 185 provided to the data extractor 190B may be extracted along with any corresponding entity names (e.g., table names) and content (e.g., personal identifiers and credit cards numbers). On the basis of the analysis performed by the data extractor 190B, the data extractor 190B may generate classification data 187 (sometimes referred to as extracted data 187). For example, the data extractor 190B can extract the field values “id” and “credit_card”, the entity name “tb1” (corresponding to a table identifier), and the content “4580111122223333” (corresponding to a credit card number) from the event log 185A. This extracted information represents the classification data 187 generated by the data extractor 190B at circle 4. Accordingly, the classification data 187 is absent any syntax information related to the original query/request that precipitated generation of the event log 185A.

At circle 5, the data extractor 190B provides the classification data 187 to the caching system 190C such that the caching system 190C can determine at circle 6 if the same or similar classification data 187 has already been classified by the classification server 190. In particular, the caching system 190C can compare the classification data 187 with sets of data (i.e., previous classification data 187) that have already been classified/scored. In one embodiment, the caching system 190C maintains a cache of recently analyzed classification data 187 while in another embodiment, the caching system 190C relies on the score database 198, which maintains (1) sensitivity scores 195 associated with each piece of classification data 187 that has already been classified/scored along with corresponding pieces of classification data 187 (e.g., one or more column/field names, one or more entity names, and one or more pieces of content) and (2) pieces of classification data 187 that were unsuccessfully classified/scored. Upon determining that a piece of classification data 187 was previously unsuccessfully classified/scored, the caching system 190C can decide to terminate a current attempt at classifying this piece of classification data 187.

In some embodiments, in response to determining that a piece of classification data 187 was already successfully classified/scored, such that a sensitivity score 195 was already generated and stored along with the classification data 187 in the score database 198, the caching system 190C can determine to generate a new sensitivity score 195 for the piece of classification data 187. As will be described below this new sensitivity score 195 may be combined with the previous sensitivity scores 195 associated with this piece of classification data 187 to maintain an aggregated sensitivity score 195 in the score database 198. In other embodiments, the caching system 190C can determine to not further process the classification data 187 upon determining that the piece of classification data 187 was previously successfully classified/scored.

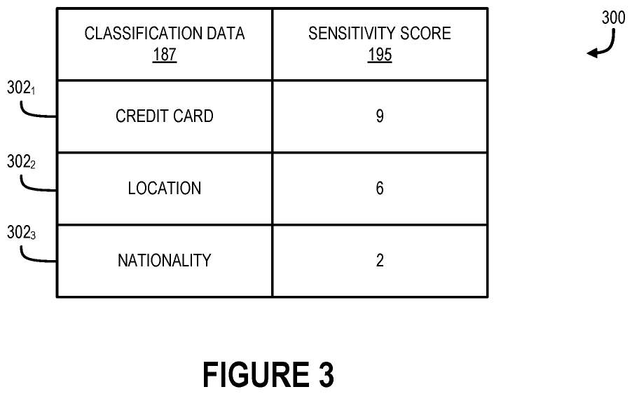

In response to the caching system 190C determining that the classification data 187 received from the data extractor 190B was not previously classified/scored or that although the classification data 187 was previously classified/scored, a new classification/scoring is desired, the caching system 190C provides the classification data 187 to the classification analyzer 190D at circle 7. At circle 8, the classification analyzer 190D determines a sensitivity score 195 for the classification data 187 that reflects whether the classification data 187 is sensitive and/or the degree to which the classification data 187 is sensitive. For example, the classification analyzer 190D can use an analyzer engine, which utilizes a regular expression, to generate a corresponding a sensitivity score 195 based on the classification data 187. The sensitivity score 195 is compared with sensitivity scores 195 from previously analyzed similar pieces of classification data 187 to determine a highest score 195. The highest sensitivity score 195 from this comparison is determined to be the sensitivity score 195 for the classification data 187. For example, when the classification data 187 contains “credit card” and “4068653946942155”, which is a valid VISA credit card number, a regular expression utilized by the classification analyzer 190D can calculate a sensitivity score 195 of “7” as the regular expression identifies the word/phrase “credit card” and can identify “4068653946942155” as a valid VISA credit card number. The classification analyzer 190D can thereafter compare the sensitivity score 195 generated for this classification data 187 against sensitivity scores 187 for similar pieces of classification data 187. In response to determining similar sensitivity scores 187 generated for similar pieces of classification data 187 (e.g., a set of sensitivity scores 195 with the value of “7” or within a threshold deviation), the classification analyzer 190D can confirm the sensitivity score 195 (e.g., the classification score 195 of “7”) and can cache the sensitivity score 195 such that similar classification data 195 will not need to be analyzed again in the future. In one embodiment, the sensitivity score 195 is stored in the score database 198 along with corresponding classification data 187 at circle 9. In one embodiment, the classification analyzer 190D may generate a sensitivity score 195 for each column/field value, entity value, and content value represented in the classification data 187. For example, FIG. 3 shows a table 300 of classification data 187 and corresponding sensitivity scores 195, according to one example embodiment. The sensitivity scores 195 in this example range from one to ten, where a sensitivity score 195 of one indicates low sensitivity of corresponding classification data 187 (e.g., the classification data 187 is not sensitive) and a sensitivity score 195 of ten indicates high sensitivity of corresponding classification data 187. As shown in FIG. 3, the first entry 3021 corresponds to classification data 187 that represents content data. In particular, the first entry 3021 corresponds to a field/column representing a credit card number of a user or entity. Since a credit card number has a high sensitivity, as it can be used to make purchases from an unsuspecting user's account, the classification analyzer 190D assigns a sensitivity score 195 of nine (i.e., a high sensitivity score 195). In contrast, the second entry 3022 corresponds to classification data 187 that represents a location field (e.g., positioning coordinates that indicate an approximate location of a user or entity). Since a location field may have sensitive data, as it can be used to track a user/entity, but it may be considered to provide less sensitive data than financial identifiers (e.g., a credit card number), the classification analyzer 190D assigns a sensitivity score 195 of six. Lastly, the third entry 3023 corresponds to classification data 187 that represents a nationality field (e.g., nationality of a user). Since knowing the nationality of a user/entity is not highly sensitive, the classification analyzer 190D assigns a sensitivity score 195 of two.

Accordingly, as described above, the classification server 190 classifies/scores data, which is stored in a database 170, based purely on an event log database 180 that captures events (e.g., transactions/operations) in relation to the database 170 but without requiring access to the database 170. In some embodiments, the sensitivity scores 195 can be (1) transmitted to the database server 160 for storage along with corresponding databases 170 and database objects 175 and/or (2) represented in a separate dashboard along with corresponding classification data 187. For example, each field/column in the database objects 175 of a database 170 can be associated with a sensitivity score 195. In one embodiment, the database server 160 may utilize these sensitivity scores 195 for safeguarding corresponding data in the databases 170. For example, the database server 160 can restrict access to particular fields, entities, pieces of content, database objects 175, and/or databases 170 based on corresponding sensitivity scores 195.

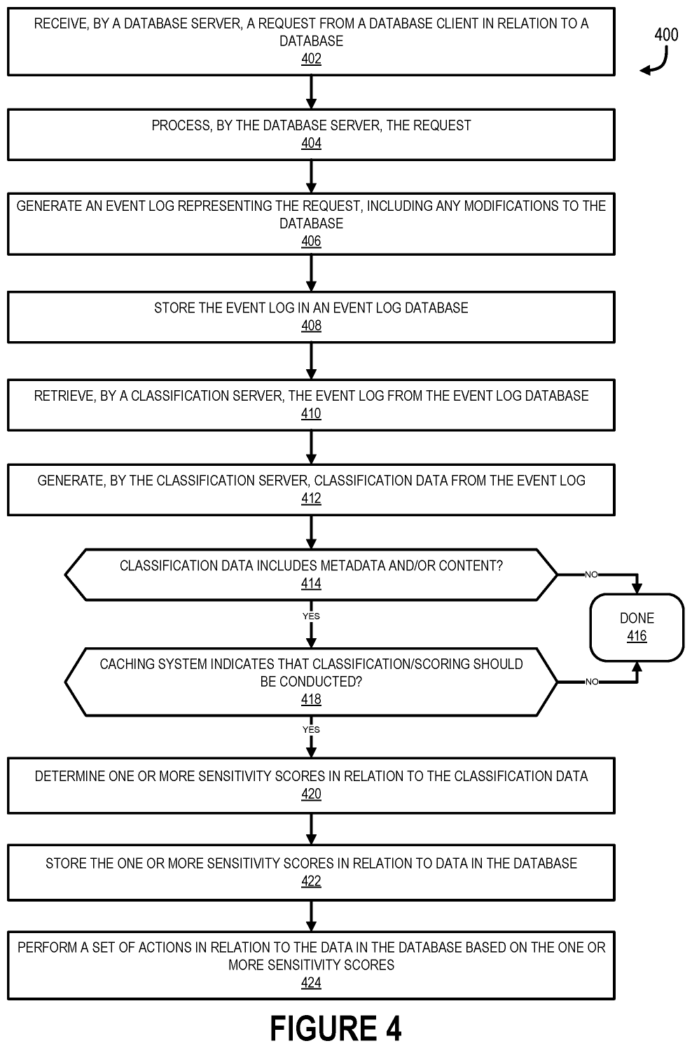

Turning now to FIG. 4, a method 400 will be described for passively classifying data in a database 170 based on event logs 185 stored in an event log database 180 and without access to the underlying database 170. The operations of the method 400 will be described in relation to one or more other figures provided herein. However, the method 400 may be performed in relation to other components. Further, although shown in a sequential order, in some embodiments, two or more operations of the method 400 may be performed in partially or entirely overlapping time periods.

As shown in FIG. 4, the method 400 may commence at operation 402 with the database server 160 receiving a request from a database client 140 in relation to a database 170. For example, the database client 140A may transmit a command/request to insert a record or modify a record represented by the database objects 175A in the database 170A. The command/request may be transmitted to the database server 160 via the connection 150A. Although described in relation to a database client 140, the method 400 can be performed irrespective to an action by a database client 140 (e.g., the method 400 can commence in response to an internal operation of the database 170A).

At operation 404, the database server 160 processes the request. In one embodiment, processing the request may include one or more of (1) modifying a record in a database 170, (2) deleting a record in a database 170, (3) inserting a record in a database, and (4) generating a response to the request, which can be also transmitted to a database client 140 via a connection 150. For example, when the database server 160 receives a request from the database client 140A to modify information stored in the database 170A (e.g., update a value with a new value or insert a new value into a corresponding field/column), the database server 160 may modify corresponding database objects 175A in the database 170A based on the request. The data that was modified may be sensitive information (e.g., credit card information, a social security number (SSN), etc.) or non-sensitive information.

At operation 406, an event log 185 is generated that represents the request, including modifications to one or more databases 170 included or otherwise managed by the database server 160 (e.g., modifications to existing records, insertion of new records, etc.). The event log 185 can include information related to the modification to the database(s) 170. For example, the event log 185 can include the query/command provided in the original request from the database client 140 or a subset of the information provided in the query/command. The event log 185 may be generated by one or more of the database server 160, including the agent 138, and the event log database 180.

At operation 408, the event log 185, which was generated at operation 406, can be stored in the event log database 180. Accordingly, the event log database 180 stores event logs 185 corresponding to each modification to the databases 170 managed by the database server 160.

At operation 410, the classification server 190, retrieves the event log 185 from the event log database 180 for processing. For example, the log retriever 190A of the classification server 190 retrieves the event log 185 from the event log database 180. In one embodiment, the event log database 180 can transmit the event log 185 to the log retriever 190A of the classification server 190 in response to storing or receipt/generation of the event log 185, while in another embodiment, the log retriever 190A of the classification server 190 can periodically poll the event log database 180 for new event logs 185.

At operation 412, the classification server 190 can generate classification data 187 based on the event log 185. In particular, the data extractor 190B can analyze the event log 185 received from the log retriever 190A to determine whether the event log 185 includes data useful in gauging the sensitivity of data provided therein, which is also stored in one or more of the databases 170. As noted above, this information may include one or more column/field names, one or more entity names, and one or more pieces of content (e.g., one or more identifiers of a user or one or more account numbers of a user) as provided in an event log 185.

At operation 414, the classification server 190 can determine if the classification data 187 includes metadata and/or content data. In particular, when the classification server 190 determines that the classification data 187 does not include metadata and/or content data (e.g., the classification data 187 does not include any useful data, including field names or content data), the method 400 concludes at operation 416. In contrast, when the classification server 190 determines that the classification data 187 includes metadata and/or content data, the method 400 moves to operation 418.

At operation 418, the classification server 190 determines if the classification/scoring should be conducted in relation to the classification data 187 corresponding to the received event log 185. For example, as described above, in some embodiments, in response to (1) previously unsuccessfully classifying/scoring classification data 187 that is similar or identical to the current classification data 187 or (2) successfully classifying/scoring classification data 187 that is similar or identical to the current classification data 187, the caching system 190C can determine to not classify/score the current classification data 187. In other embodiments, in response to (1) previously successfully classifying/scoring classification data 187 that is similar or identical to the current classification data 187 or (2) determining that similar or identical classification data 187 has never been classified/scored, the caching system 190C can determine to classify/score the current classification data 187.

In response to determining at operation 418 to not classify/score the current classification data 187, the method 400 concludes at operation 416. Conversely, in response to determining at operation 418 to classify/score the current classification data 187, the method 400 moves to operation 420.

At operation 420, the classification server 160 determines a sensitivity score 195 for the classification data 187 that reflects whether the classification data 187 is sensitive or the degree of sensitivity associated with the current classification data 187. In one embodiment, the classification analyzer 190D may generate a sensitivity score 195 for each column/field represented in the classification data 187. At operation 422, the sensitivity scores 195 generated at operation 420 can be stored in the score database 198. In some embodiments, when a sensitivity score 195 was previously generated for similar or identical classification data 187, storing the currently generated sensitivity score 195 can include averaging the current sensitivity score 195 with any previously generated sensitivity scores 195, which are associated with the same or similar pieces of classification data 187. Accordingly, an aggregate sensitivity score 195 may be maintained for particular pieces of classification data 187. In other embodiments, the currently generated sensitivity score 195 can replace any previous sensitivity scores 195, which are associated with the same or similar pieces of classification data 187.

At operation 424, the system 100 can perform a set of actions in relation to data in one or more of the databases 170 based on the sensitivity score 195. For example, the database server 160 can manage permissions associated with data stores in the databases 170 based on the sensitivity score 195. This can include allowing or denying access (e.g., read or write access) to a consumer of the data. Data can be a field/column in a database 170, a table in a database, a record in a database 170, and/or a set of records or tables in a database 170 that share a characteristic/attribute (e.g., records related to a particular user).

Accordingly, as described above, the classification server 190 classifies/scores data, which is stored or otherwise represented in a database 170, based purely on an event log database 180 that captures events in relation to the database 170 but without requiring access to the database 170. In some embodiments, the sensitivity scores 195 can be transmitted to the database server 160 for storage along with corresponding databases 170 and database objects 175. In one embodiment, the database server 160 may utilize these sensitivity scores 195 for safeguarding corresponding data in the databases 170. For example, the database server 160 can restrict access to particular columns/fields, entities, pieces of content, database objects 175, and/or databases 170 on the basis of sensitivity scores 195.

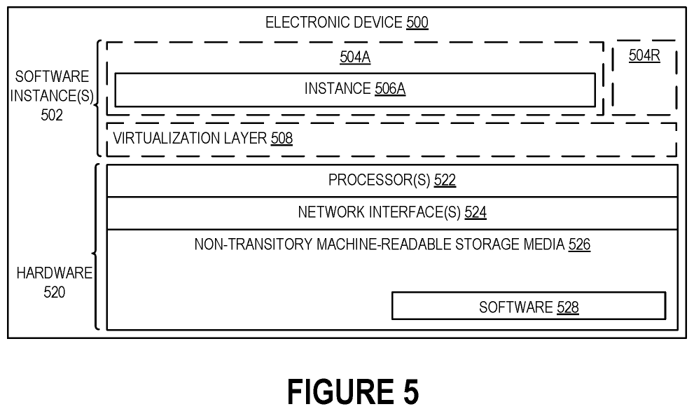

FIG. 5 is a block diagram illustrating an electronic device, according to some embodiments. FIG. 5 includes hardware 520 comprising a set of one or more processor(s) 522, a set of one or more network interfaces 524 (wireless and/or wired), and non-transitory machine-readable storage media 526 having stored therein software 528 (which includes instructions executable by the set of one or more processor(s) 522). Software 528 can include code, which when executed by hardware 520, causes the electronic device 500 to perform operations of one or more embodiments described herein (e.g., the operations of one or more components of the system 100).

In electronic devices that use compute virtualization, the set of one or more processor(s) 522 typically execute software to instantiate a virtualization layer 508 and software container(s) 504A-R (e.g., with operating system-level virtualization, the virtualization layer 508 represents the kernel of an operating system (or a shim executing on a base operating system) that allows for the creation of multiple software containers 504A-R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 528 (illustrated as instance 506A) is executed within the software container 504A on the virtualization layer 508. In electronic devices where compute virtualization is not used, the instance 506A on top of a host operating system is executed on the “bare metal” electronic device 500. The instantiation of the instance 506A, as well as the virtualization layer 508 and software containers 504A-R if implemented, are collectively referred to as software instance(s) 502.

Alternative implementations of an electronic device may have numerous variations from that described above. For example, customized hardware and/or accelerators might also be used in an electronic device.

The techniques shown in the figures can be implemented using code and data stored and executed on one or more electronic devices (e.g., an end station, a network device). Such electronic devices, which are also referred to as computing devices, store and communicate (internally and/or with other electronic devices over a network) code and data using computer-readable media, such as non-transitory computer-readable storage media (e.g., magnetic disks, optical disks, random access memory (RAM), read-only memory (ROM); flash memory, phase-change memory) and transitory computer-readable communication media (e.g., electrical, optical, acoustical or other form of propagated signals, such as carrier waves, infrared signals, digital signals). In addition, electronic devices include hardware, such as a set of one or more processors coupled to one or more other components, e.g., one or more non-transitory machine-readable storage media to store code and/or data, and a set of one or more wired or wireless network interfaces allowing the electronic device to transmit data to and receive data from other computing devices, typically across one or more networks (e.g., Local Area Networks (LANs), the Internet). The coupling of the set of processors and other components is typically through one or more interconnects within the electronic device, (e.g., busses, bridges). Thus, the non-transitory machine-readable storage media of a given electronic device typically stores code (i.e., instructions) for execution on the set of one or more processors of that electronic device. Of course, various parts of the various embodiments presented herein can be implemented using different combinations of software, firmware, and/or hardware. As used herein, a network device (e.g., a router, switch, bridge) is an electronic device that is a piece of networking equipment, including hardware and software, which communicatively interconnects other equipment on the network (e.g., other network devices, end stations). Some network devices are “multiple services network devices” that provide support for multiple networking functions (e.g., routing, bridging, switching), and/or provide support for multiple application services (e.g., data, voice, and video).

The operations in the flow diagrams have been described with reference to the exemplary embodiments of the other diagrams. However, it should be understood that the operations of the flow diagrams can be performed by embodiments of the invention other than those discussed with reference to these other diagrams, and the embodiments of the invention discussed with reference these other diagrams can perform operations different than those discussed with reference to the flow diagrams.

Similarly, while the flow diagrams in the figures show a particular order of operations performed by certain embodiments, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method for passively classifying data in a database based on event logs stored in an event log database, the method comprising:
retrieving, by a classification server, a first event log from the event log database, wherein the first event log represents a transaction involving a client device and the database;
extracting, by the classification server, one or more pieces of information from the first event log to generate classification data;
generating, by the classification server, a set of sensitivity scores corresponding to the one or more pieces of information, wherein each sensitivity score indicates the level of sensitivity associated with a corresponding piece of information from the one or more pieces of information; and
storing, by the classification server, the set of sensitivity scores in a score database.

2. The method of claim 1, wherein the extracting includes extracting one or more of (1) a field name indicated in the first event log, (2) an entity name indicated in the first event log, and (3) content data, which includes data relating a user.

3. The method of claim 1, further comprising:
determining, by the classification server, whether an attempt to classify the classification data was previously attempted in relation to a second event log; and
determining, by the classification server, to forgo generating the set of sensitivity scores for the one or more piece of information of the classification data in response to determining that an unsuccessful attempt was made to classify the classification data in relation to the second event log.

4. The method of claim 3, further comprising:
determining, by the classification server, to generate the set of sensitivity scores for the one or more piece of information of the classification data in response to determining that a successful attempt was made to classify the classification data in relation to the second event log; and
aggregating, by the classification server, the set of sensitivity scores from the one or more piece of information with sensitivity scores generated in relation to the second event log to produce an aggregated set of scores, wherein storing the set of sensitivity scores in the score database includes storing the aggregated set of scores.

5. The method of claim 1, wherein the first event log is generated based on a request from a client device in relation to data stored in the database, and
wherein the request is one of (1) a request to insert a record into the database, (2) a request to modify a record in the database, and (3) a request to delete a record from the database.

6. The method of claim 1, further comprising:
storing, by the classification server, the set of sensitivity scores in the database.

7. The method of claim 1, further comprising:
performing, by a database server that manages the database, a set of actions to secure data in the database based on the set of sensitivity scores, wherein the set of actions include limiting access of data in the database to a set of consumers based on the set of sensitivity scores.

8. A set of one or more non-transitory computer readable storage media storing instructions which, when executed by one or more processors of one or more computing devices, cause the one or more computing devices to perform operations for passively classifying data in a database based on event logs stored in an event log database, the operations comprising:
retrieving a first event log from the event log database, wherein the first event log represents a transaction involving a client device and the database;
extracting one or more pieces of information from the first event log to generate classification data;
generating a set of sensitivity scores corresponding to the one or more pieces of information, wherein each sensitivity score indicates the level of sensitivity associated with a corresponding piece of information from the one or more pieces of information; and
storing the set of sensitivity scores in a score database.

9. The set of one or more non-transitory computer readable storage media of claim 8, wherein the extracting includes extracting one or more of (1) a field name indicated in the first event log, (2) an entity name indicated in the first event log, and (3) content data, which includes data relating a user.

10. The set of one or more non-transitory computer readable storage media of claim 8, wherein the operations further comprise:
determining whether an attempt to classify the classification data was previously attempted in relation to a second event log; and
determining to forgo generating the set of sensitivity scores for the one or more piece of information of the classification data in response to determining that an unsuccessful attempt was made to classify the classification data in relation to the second event log.

11. The set of one or more non-transitory computer readable storage media of claim 10, wherein the operations further comprise:
determining to generate the set of sensitivity scores for the one or more piece of information of the classification data in response to determining that a successful attempt was made to classify the classification data in relation to the second event log; and
aggregating the set of sensitivity scores from the one or more piece of information with sensitivity scores generated in relation to the second event log to produce an aggregated set of scores, wherein storing the set of sensitivity scores in the score database includes storing the aggregated set of scores.

12. The set of one or more non-transitory computer readable storage media of claim 8, wherein the first event log is generated based on a request from a client device in relation to data stored in the database, and
wherein the request is one of (1) a request to insert a record into the database, (2) a request to modify a record in the database, and (3) a request to delete a record from the database.

13. The set of one or more non-transitory computer readable storage media of claim 8, wherein the operations further comprise:
storing the set of sensitivity scores in the database.

14. The set of one or more non-transitory computer readable storage media of claim 8, wherein the operations further comprise:
performing a set of actions to secure data in the database based on the set of sensitivity scores, wherein the set of actions include limiting access of data in the database to a set of consumers based on the set of sensitivity scores.

15. A computing device configured to passively classify data in a database based on event logs stored in an event log database, the computing device comprising:
one or more processors; and
a non-transitory machine-readable storage medium having instructions stored therein, which when executed by the one or more processors, causes the computing device to:
retrieve a first event log from the event log database, wherein the first event log represents a transaction involving a client device and the database;
extract one or more pieces of information from the first event log to generate classification data;
generate a set of sensitivity scores corresponding to the one or more pieces of information, wherein each sensitivity score indicates the level of sensitivity associated with a corresponding piece of information from the one or more pieces of information; and
store the set of sensitivity scores in a score database.

16. The computing device of claim 15, wherein the extracting includes extracting one or more of (1) a field name indicated in the first event log, (2) an entity name indicated in the first event log, and (3) content data, which includes data relating a user.

17. The computing device of claim 15, wherein the instructions further cause the computing device to:
determine whether an attempt to classify the classification data was previously attempted in relation to a second event log; and
determine to forgo generating the set of sensitivity scores for the one or more piece of information of the classification data in response to determining that an unsuccessful attempt was made to classify the classification data in relation to the second event log.

18. The computing device of claim 17, wherein the instructions further cause the computing device to:
determine to generate the set of sensitivity scores for the one or more piece of information of the classification data in response to determining that a successful attempt was made to classify the classification data in relation to the second event log; and
aggregate the set of sensitivity scores from the one or more piece of information with sensitivity scores generated in relation to the second event log to produce an aggregated set of scores, wherein storing the set of sensitivity scores in the score database includes storing the aggregated set of scores.

19. The computing device of claim 15, wherein the first event log is generated based on a request from a client device in relation to data stored in the database, and
wherein the request is one of (1) a request to insert a record into the database, (2) a request to modify a record in the database, and (3) a request to delete a record from the database.

20. The computing device of claim 15, wherein the instructions further cause the computing device to:
perform a set of actions to secure data in the database based on the set of sensitivity scores, wherein the set of actions include limiting access of data in the database to a set of consumers based on the set of sensitivity scores.
